(19) United States
(12) Patent Application Publication
(10) Pub. No.: US 2025/0193953 A1
(43) Pub. Date: Jun. 12, 2025

(54) BASE STATION AND WIRELESS TERMINAL APPARATUS

(71) Applicant: Nippon Telegraph and Telephone Corporation, Tokyo (JP)

(72) Inventors: Akira KISHIDA, Musashino-shi, Tokyo (JP); Kengo NAGATA, Musashino-shi, Tokyo (JP); Shoko SHINOHARA, Musashino-shi, Tokyo (JP); Hanae OTANI, Musashino-shi, Tokyo (JP); Yusuke Asai, Musashino-shi, Tokyo (JP); Yasushi TAKATORI, Musashino-shi, Tokyo (JP)

(21) Appl. No.: 18/840,369

(22) PCT Filed: Feb. 28, 2022
(86) PCT No.: PCT/JP2022/008242

§ 371 Date: Aug. 21, 2024

(51) Int. Cl. H04W 76/15; H04W 72/21

(52) U.S. Cl. CPC H04W 76/15; H04W 72/21

(57) ABSTRACT

A base station of the embodiment includes a first wireless signal processing unit, a second wireless signal processing unit, and a link management unit. The link management unit establishes a multilink with a wireless terminal apparatus by using the first wireless signal processing unit and the second wireless signal processing unit. The link management unit generates a trigger frame for causing the wireless terminal apparatus to transmit uplink data, and causes each of the first wireless signal processing unit and the second wireless signal processing unit to transmit the trigger frame.

### TECHNICAL FIELD

Embodiments described herein relate to a base station and a wireless terminal apparatus.

### BACKGROUND ART

A wireless local area network (LAN) is known as an information communication system that wirelessly connects a base station to a wireless terminal apparatus.

### CITATION LIST

### Non Patent Literature

Non Patent Literature 1: IEEE Std 802.11™-2020, “10.47 Target wake time (TWT)”, published 26 Feb. 2021

### SUMMARY OF INVENTION

### Technical Problem

A problem is to curb a delay of data transmitted on an uplink.

### Solution to Problem

A base station of the embodiment includes a first wireless signal processing unit, a second wireless signal processing unit, and a link management unit. The link management unit establishes a multilink with a wireless terminal apparatus by using the first wireless signal processing unit and the second wireless signal processing unit. The link management unit generates a trigger frame for causing the wireless terminal apparatus to transmit uplink data, and causes each of the first wireless signal processing unit and the second wireless signal processing unit to transmit the trigger frame.

### Advantageous Effects of Invention

The base station of the embodiment can curb a delay of data transmitted on the uplink.

### BRIEF DESCRIPTION OF DRAWINGS

FIG. 1 is a conceptual diagram illustrating one example of an overall configuration of an information communication system according to an embodiment.

FIG. 2 is a conceptual diagram illustrating one example of frequency bands used in wireless communication in the information communication system according to the embodiment.

FIG. 3 is a table illustrating one example of a link state of a base station and a wireless terminal apparatus included in the information communication system according to the embodiment.

FIG. 4 is a block diagram illustrating one example of a hardware configuration of the base station included in the information communication system according to the embodiment.

FIG. 5 is a block diagram illustrating one example of a hardware configuration of the wireless terminal apparatus included in the information communication system according to the embodiment.

FIG. 6 is a block diagram illustrating one example of a functional configuration of the base station included in the information communication system according to the embodiment.

FIG. 7 is a block diagram illustrating one example of a functional configuration of a MAC frame processing unit of the base station included in the information communication system according to the embodiment.

FIG. 8 is a block diagram illustrating one example of a functional configuration of the wireless terminal apparatus included in the information communication system according to the embodiment.

FIG. 9 is a block diagram illustrating one example of a functional configuration of a MAC frame processing unit of the wireless terminal apparatus included in the information communication system according to the embodiment.

FIG. 10 is a flowchart illustrating one example of a multilink setup method in the information communication system according to the embodiment.

FIG. 11 is a sequence diagram illustrating an outline of an uplink data transmission method when the target wake time (TWT) function is used in the information communication system according to the embodiment.

FIG. 12 is a conceptual diagram illustrating one example of a format of a trigger frame transmitted in the TWT period of the information communication system according to the embodiment.

FIG. 13 is a sequence diagram illustrating one example of a beacon transmission and reception method in the information communication system according to the embodiment.

FIG. 14 is a conceptual diagram illustrating one example of a format of a beacon including a TWT setting used in the information communication system according to the embodiment.

FIG. 15 is a sequence diagram illustrating one example of an uplink data transmission method when the TWT function of the information communication system according to the embodiment is used.

### DESCRIPTION OF EMBODIMENTS

Hereinafter, an information communication system according to embodiments will be described with reference to the drawings. Each embodiment exemplifies a device and a method of embodying the technical idea of the invention. The drawings are schematic or conceptual. In the following description, constituent elements having substantially the same function and configuration are denoted by the same reference numerals. Numbers or the like following characters in reference numerals are used to distinguish between elements referred to by reference numerals including the same characters and having similar configurations. Where elements denoted by reference numerals containing the same characters do not need to be distinguished from one another, these elements are referred to by reference numerals containing only characters.

### EMBODIMENT

Hereinafter, an information communication system 1 according to an embodiment will be described.

### <1> Configuration

### <1-1> Overall Configuration

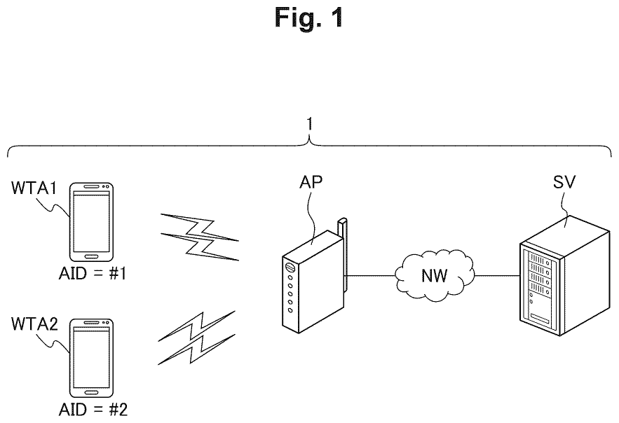

FIG. 1 is a conceptual diagram illustrating one example of an overall configuration of the information communication system 1 according to the embodiment. As illustrated in FIG. 1, the information communication system 1 includes, for example, a base station (access point) AP, at least one wireless terminal apparatus WTA, and a server SV.

The base station AP is a wireless LAN access point or a wireless LAN router. The base station AP is configured to be connectable to a network NW. The base station AP is configured to be wirelessly connectable to one or more wireless terminal apparatuses WTA by using one type or a plurality of types of bands. A Multilink can be used for wireless connection between the base station AP and the wireless terminal apparatus WTA. The multilink is a wireless connection in which data can be transmitted and received using a plurality of links.

The wireless terminal apparatus WTA is a wireless terminal such as a smartphone or a tablet computer. The wireless terminal apparatus WTA is configured to be connectable to the base station AP that has established a link. The wireless terminal apparatus WTA may be an electronic apparatus such as a desktop computer or a laptop computer. A terminal identifier AID is added to the wireless terminal apparatus WTA. The base station AP can identify a plurality of wirelessly-connected wireless terminal apparatuses WTA by the terminal identifier AID. In the present example, a wireless terminal apparatus WTA1 having an AID=#1 and a wireless terminal apparatus WTA2 having an AID=#2 are connected to the base station AP.

The server SV is a computer configured to be connectable to the network NW. The server SV is configured to be able to communicate with the base station AP via the network NW. The server SV stores, for example, data of content for which the wireless terminal apparatus WTA is a target. The server SV can transmit and receive data to and from the wireless terminal apparatus WTA via the base station AP. Communication between the base station AP and the server SV may be wireless communication or may be a combination of wireless communication and wired communication.

The wireless communication between the base station AP and the wireless terminal apparatus WTA conforms to the IEEE 802.11 standard. In the IEEE 802.11 standard, the MAC sublayers of the first layer and the second layer of the open systems interconnection (OSI) reference model are specified. In the OSI reference model, a communication function is divided into seven layers (first layer: physical layer, second layer: data link layer, third layer: network layer, fourth layer: transport layer, fifth layer: session layer, sixth layer: presentation layer, and seventh layer: application layer). The second layer (data link layer) includes the logical link control (LLC) sublayer and the media access control (MAC) sublayer. An outline of each of the LLC sublayer and the MAC sublayer will be described later.

In addition, the base station AP can use a target wake time (TWT) function for communication with the wireless terminal apparatus WTA. When the TWT function is used, a certain cycle is set between the base station AP and the wireless terminal apparatus WTA, and the base station AP gives a transmission opportunity to the wireless terminal apparatus WTA every certain cycle. The wireless terminal apparatus WTA can curb power consumption by setting a period other than the certain cycle set by the TWT function to a power saving state. In the TWT function, a period (hereinafter also referred to as a TWT service period) during which the base station AP gives a transmission opportunity to the wireless terminal apparatus WTA is set to be short in a case where curbing of power consumption is prioritized, and is set to be long in a case where improvement of latency is prioritized, for example. In addition, the wireless terminal apparatus WTA can improve latency of data (hereinafter referred to as low latency data) requested to have a low delay by preferentially transmitting the low latency data in the TWT service period. The TWT function in the embodiment executes processing for further curbing latency in transmission of uplink data from the wireless terminal apparatus WTA to the base station AP. A detailed operation of the TWT function in the embodiment will be described later.

### (Frequency Band Used by Base Station AP and Wireless Terminal Apparatus WTA)

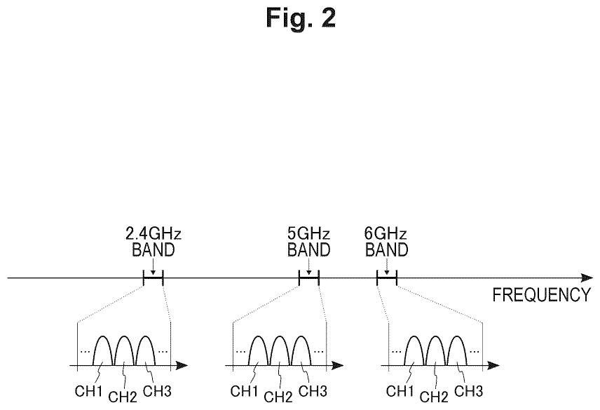

FIG. 2 is a conceptual diagram illustrating one example of frequency bands used in wireless communication in the information communication system 1 according to the embodiment. As illustrated in FIG. 2, in the wireless communication between the base station AP and the wireless terminal apparatus WTA, for example, a 2.4 GHz band, a 5 GHz band, and a 6 GHz band is used. Each frequency band includes a plurality of channels. FIG. 2 illustrates a case where each of the 2.4 GHz band, the 5 GHz band, and the 6 GHz band includes three channels CH1, CH2, and CH3. Note that a frequency band other than the 2.4 GHz band, the 5 GHz band, and the 6 GHz band may be used for wireless communication. It is sufficient that at least one channel CH is allocated to each frequency band. In a multilink, two or more channels CH are used. The plurality of channels CH used in a multilink may be the same frequency band or different frequency bands.

### (One Example of Link State)

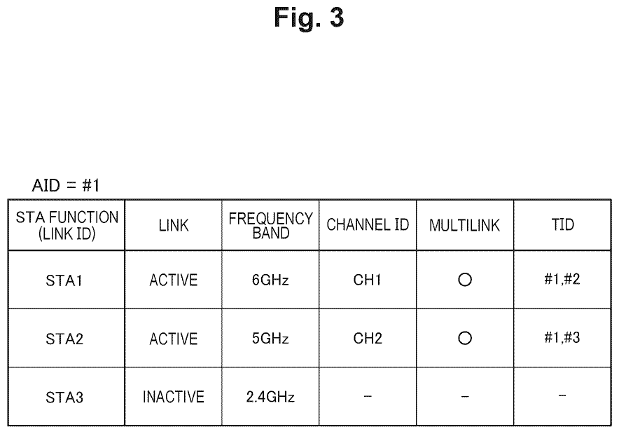

FIG. 3 is a table illustrating one example of link management information held by the base station AP included in the information communication system 1 according to the embodiment. Link management information is information for managing a link state of each wireless terminal apparatus WTA wirelessly connected to the base station AP. FIG. 3 illustrates a link state related to the wireless terminal apparatus WTA having the AID=#1. As illustrated in FIG. 3, the link management information includes, for example, information regarding each of “STA function”, “link”, “frequency band”, “channel ID”, “multilink”, and “traffic identifier (TID)”.

“STA function” indicates a link identifier (Link ID) associated with the STA function. The STA function corresponds to a wireless signal processing unit included in each of the base station AP and the wireless terminal apparatus WTA. Each STA function may use one or more channels. In the following description, it is assumed that each STA function uses one channel. The STA function of the base station AP and the STA function of the wireless terminal apparatus WTA are paired to form one link. In the present example, three STA functions (hereinafter referred to as STA1, STA2, and STA3) are allocated to the wireless communication between the wireless terminal apparatus WTA having the AID=#1 and the base station AP.

“Link” indicates whether or not a link is established. In the present example, it is indicated that each of STA1 and STA2 has an established link (“active” in FIG. 3), and it is indicated that STA3 does not have an established link (“inactive” in FIG. 3).

“Frequency band” indicates a frequency band used for the link. In the present example, the 6 GHz band, the 5 GHz band, and the 2.4 GHz band are allocated to STA1, STA2, and STA3, respectively.

“Channel ID” indicates an ID of a channel used for a link. In the present example, channel CH1 of the 6 GHz band is allocated to STA1, and channel CH2 of the 5 GHz band is allocated to STA2.

“Multilink” indicates whether or not multilink is established. In the present example, a set of STA1 and STA2 establishes a multilink (“∘” in FIG. 3).

“TID” indicates the traffic type allocated to the link (STA function). The TID is an identifier indicating a type of traffic (data). The traffic type includes, for example, “voice (VO)”, “video (VI)”, “best effort (BE)”, “background (BK)”, and “low latency (LL)”. LL is traffic (low latency data) which is set to have a higher priority than other traffic and for which low latency is required. Each of #1 to #3 of “TID” in FIG. 3 corresponds to any of VO, VI, BE, BK, and LL. In the present example, TID #1 is allocated to STA and STA2, TID #2 is allocated to STA1, and TID #3 is allocated to STA2.

As described above, in the multilink, one or a plurality of STA functions can be allocated to one TID. For example, the association between the traffic and the STA function is set such that a traffic amount (data amount) is equal among a plurality of links forming the multilink. The present invention is not limited thereto, and traffic of similar types (priority/non-priority and the like) may be collected in a specific link forming a multilink. Transmission of low latency data preferably uses a multilink and is assigned a plurality of links in order to improve latency.

### <1-2> Hardware Configuration

Hereinafter, a hardware configuration of each of the base station AP and the wireless terminal apparatus WTA will be described.

### (Hardware Configuration of Base Station AP)

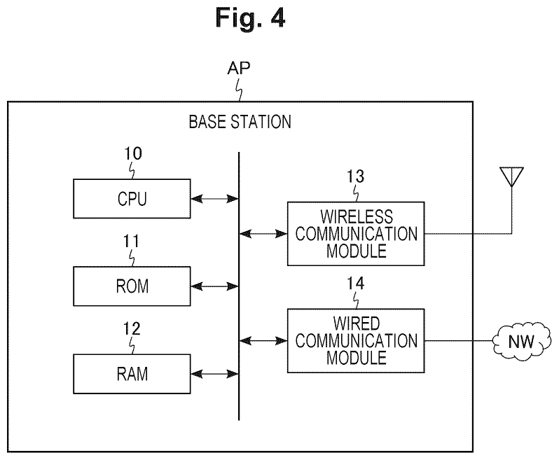

FIG. 4 is a block diagram illustrating one example of a hardware configuration of the base station AP included in the information communication system 1 according to the embodiment. As illustrated in FIG. 4, the base station AP includes, for example, a central processing unit (CPU) 10, a read only memory (ROM) 11, a random access memory (RAM) 12, a wireless communication module 13, and a wired communication module 14.

The CPU 10 is an integrated circuit capable of executing various programs and controls an operation of the entire base station AP. The ROM 11 is a nonvolatile semiconductor memory and stores a program for controlling the base station AP, control data, and the like. The RAM 12 is, for example, a volatile semiconductor memory and is used as a working area of the CPU 10. The wireless communication module 13 is a circuit used to transmit and receive data with a wireless signal and is configured to be connectable to an antenna. In addition, the wireless communication module 13 may include a plurality of communication modules respectively corresponding to a plurality of frequency bands. The wired communication module 14 is a circuit used to transmit and receive data with a wired signal and is configured to be connectable to the network NW. Note that the base station AP may have another hardware configuration. For example, when the base station AP is wirelessly connected to the network NW, the wired communication module 14 may be omitted from the base station AP.

### (Hardware Configuration of Wireless Terminal Apparatus WTA)

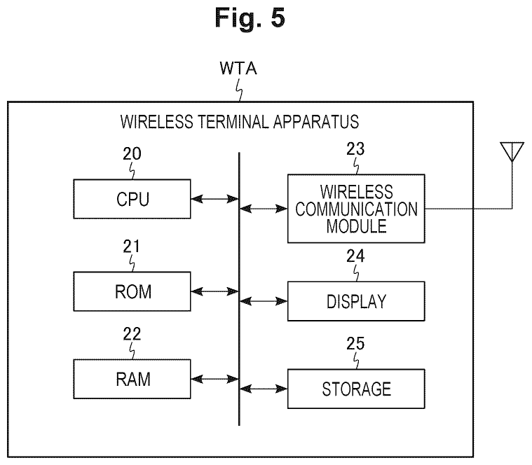

FIG. 5 is a block diagram illustrating one example of a hardware configuration of the wireless terminal apparatus WTA included in the information communication system 1 according to the embodiment. As illustrated in FIG. 5, the wireless terminal apparatus WTA includes, for example, a CPU 20, a ROM 21, a RAM 22, a wireless communication module 23, a display 24, and a storage 25.

The CPU 20 is an integrated circuit capable of executing various programs and controls an operation of the entire wireless terminal apparatus WTA. The ROM 21 is a nonvolatile semiconductor memory and stores a program for controlling the wireless terminal apparatus WTA, control data, and the like. The RAM 22 is, for example, a volatile semiconductor memory and is used as a working area of the CPU 20. The wireless communication module 23 is a circuit used to transmit and receive data by a wireless signal and is configured to be connectable to an antenna. Furthermore, the wireless communication module 23 can include, for example, a plurality of communication modules respectively corresponding to a plurality of frequency bands. The display 24 displays, for example, a graphical user interface (GUI) corresponding to application software. The display 24 may have a function as an input interface of the wireless terminal apparatus WTA. The storage 25 is a nonvolatile storage device, and stores, for example, system software or the like of the wireless terminal apparatus WTA. Note that the wireless terminal apparatus WTA may have another hardware configuration. For example, when the wireless terminal apparatus WTA is an Internet of Things (IoT) terminal or the like, the display 24 may be omitted from the wireless terminal apparatus WTA.

### <1-3> Functional Configuration

Hereinafter, a functional configuration of each of the base station AP and the wireless terminal apparatus WTA will be described.

### (Functional Configuration of Base Station AP)

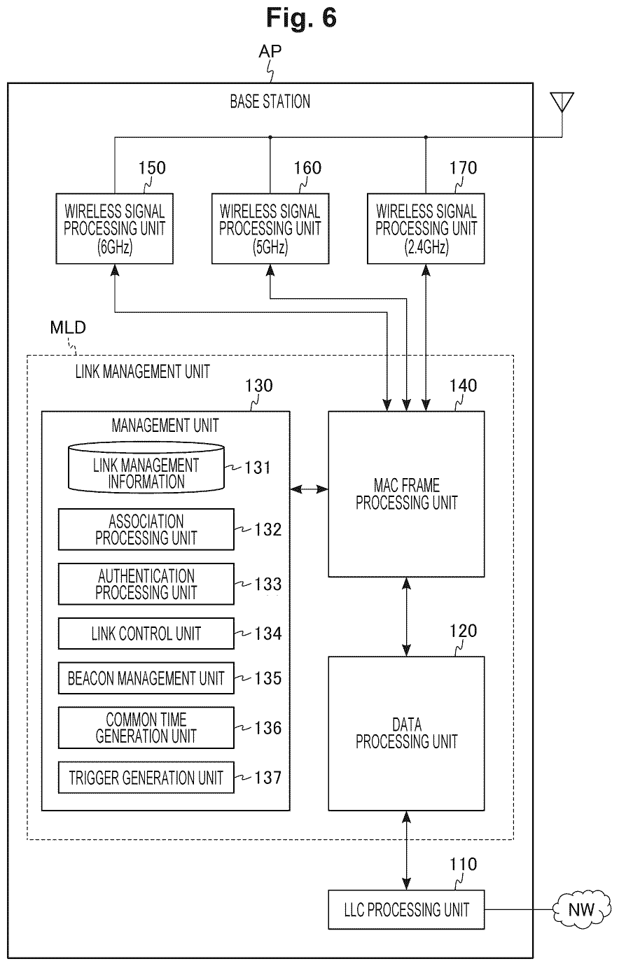

FIG. 6 is a block diagram illustrating one example of a functional configuration of the base station AP included in the information communication system 1 according to the embodiment. As illustrated in FIG. 6, the base station AP includes, for example, an LLC processing unit 110, a data processing unit 120, a management unit 130, a MAC frame processing unit 140, and wireless signal processing units 150, 160, and 170. The LLC processing unit 110 can be implemented by a combination of the CPU 10, the RAM 12, and the wired communication module 14. Processing of the data processing unit 120, the management unit 130, the MAC frame processing unit 140, and the wireless signal processing units 150, 160, and 170 can be implemented by, for example, a combination of the CPU 10, the RAM 12, and the wireless communication module 13.

The LLC processing unit 110 executes, for example, processing of the LLC sublayer of the second layer and processing of the third layer to the seventh layer on input data. The data processing unit 120, the management unit 130, and the MAC frame processing unit 140 execute second-layer MAC sublayer processing on the input data. The wireless signal processing units 150, 160, and 170 execute first-layer processing on the input data. Hereinafter, a set of the data processing unit 120, the management unit 130, and the MAC frame processing unit 140 included in the base station AP is also referred to as “link management unit MLD of the base station AP”.

Hereinafter, details of each functional configuration included in the base station AP will be described.

The LLC processing unit 110 receives data from the server SV via the network NW, for example. Then, the LLC processing unit 110 adds a destination service access point (DSAP) header, a source service access point (SSAP) header, and the like to the received data to generate an LLC packet. Then, the LLC processing unit 110 inputs the generated LLC packet to the data processing unit 120. In addition, the LLC processing unit 110 receives the LLC packet from the data processing unit 120 and extracts data from the received LLC packet. Then, the LLC processing unit 110 transmits the extracted data to the server SV via the network NW.

The data processing unit 120 adds a MAC header to the LLC packet input from the LLC processing unit 110 to generate a MAC frame. Then, the data processing unit 120 inputs the generated MAC frame to the MAC frame processing unit 140. In addition, the data processing unit 120 receives the MAC frame from the MAC frame processing unit 140 and extracts the LLC packet from the received MAC frame. Then, the data processing unit 120 inputs the extracted LLC packet to the LLC processing unit 110. Hereinafter, a MAC frame including data is also referred to as a “data frame”.

The management unit 130 manages the state of the link between the base station AP and the wireless terminal apparatus WTA. Information related to control, management, and the like of a link can be exchanged between the management unit 130 and the MAC frame processing unit 140. Furthermore, the management unit 130 can instruct the MAC frame processing unit 140 to execute predetermined processing. The management unit 130 includes, for example, link management information 131, an association processing unit 132, an authentication processing unit 133, a link control unit 134, a beacon management unit 135, a common time generation unit 136, and a trigger generation unit 137.

The link management information 131 is a table including information related to a link between the base station AP and the wireless terminal apparatus WTA wirelessly connected thereto, and includes, for example, the information illustrated in FIG. 3.

The association processing unit 132 executes a protocol related to an association in a case where a connection request from the wireless terminal apparatus WTA is received.

The authentication processing unit 133 executes a protocol related to authentication subsequent to the association. Hereinafter, a MAC frame including information related to control such as association and authentication is also referred to as a “management frame”.

The link control unit 134 controls the state of a link with the wirelessly-connected wireless terminal apparatus WTA for each AID. Furthermore, the link control unit 134 can determine association between a traffic type (TID) and an STA function when establishing multilink.

The beacon management unit 135 manages information transmitted as a beacon by the base station AP. The beacon management unit 135 generates, for example, a MAC frame including management information, and inputs the MAC frame to the MAC frame processing unit 140. Management information includes a control value used in the TWT function. A beacon is a type of management frame.

The common time generation unit 136 is a clock, and generates time information. Time information is used, for example, when the link control unit 134 uses the TWT function. Time information may be referred to by the MAC frame processing unit 140.

The trigger generation unit 137 generates a MAC frame including trigger information and inputs the MAC frame to the MAC frame processing unit 140. Trigger information includes information instructing transmission of uplink data when the TWT function is used. Specifically, trigger information includes information indicating a resource (frequency, transmission timing, period) for transmission to the wireless terminal apparatus WTA that transmits uplink data when the TWT function is used. Hereinafter, a MAC frame including trigger information is referred to as a “trigger frame”. Note that instead of generating the trigger frame, the trigger generation unit 137 may instruct the MAC frame processing unit 140 to generate the trigger frame together with designation of time.

The MAC frame processing unit 140 receives the MAC frame from the data processing unit 120 or the management unit 130, and temporarily stores (buffers) the received MAC frame. The MAC frame processing unit 140 then refers to the link management information 131 to identify a link associated with a TID of data included in the MAC frame. Then, the MAC frame processing unit 140 executes carrier sensing. Carrier sensing is processing of confirming the situation of a channel corresponding to the identified link. In a case where the channel is in a busy state, the MAC frame processing unit 140 continues the carrier sensing. In a case where the channel is in an idle state, the MAC frame processing unit 140 inputs the MAC frame to the wireless signal processing unit corresponding to the channel. Further, the MAC frame processing unit 140 receives the MAC frames from the wireless signal processing units 150, 160, and 170, and inputs the MAC frames to the data processing unit 120 or the management unit 130 according to the type of the MAC frames. Specifically, in a case where the MAC frame is a data frame, the MAC frame processing unit 140 inputs the MAC frame to the data processing unit 120, and in a case where the MAC frame is a management frame, the MAC frame processing unit 140 inputs the MAC frame to the management unit 130.

The wireless signal processing unit 150 adds a preamble, a physical layer (PHY) header, and the like to the data input from the MAC frame processing unit 140 to generate a wireless frame. Then, the wireless signal processing unit 150 performs a predetermined modulation operation on the wireless frame to convert the wireless frame into a wireless signal, and radiates (transmits) the wireless signal via the antenna. The predetermined modulation operation or the like includes convolutional coding, interleaving, subcarrier modulation, inverse fast Fourier transform (IFFT), orthogonal frequency division multiplexing (OFDM) modulation, and frequency transform, for example. Further, the wireless signal processing unit 150 receives a wireless signal from the wireless terminal apparatus WTA via the antenna, and performs a predetermined demodulation operation on the received wireless signal to obtain a wireless frame. The predetermined demodulation operation or the like includes frequency transform, OFDM demodulation, fast Fourier transform (FFT), subcarrier demodulation, deinterleaving, and Viterbi decoding, for example. Then, the wireless signal processing unit 150 extracts the MAC frame from the wireless frame, and inputs the extracted MAC frame to the MAC frame processing unit 140. The functions of the wireless signal processing units 160 and 170 are similar to those of the wireless signal processing unit 150. In the present example, the wireless signal processing units 150, 160, and 170 handle wireless signals of the 6 GHz band, the 5 GHz band, and the 2.4 GHz band, respectively. That is, the wireless signal processing units 150, 160, and 170 correspond to STA1, STA2, and STA3 of the base station AP, respectively. Note that the wireless signal processing units 150, 160, and 170 may share an antenna or may use individual antennas.

### (Functional Configuration of MAC Frame Processing Unit 140 of Base Station AP)

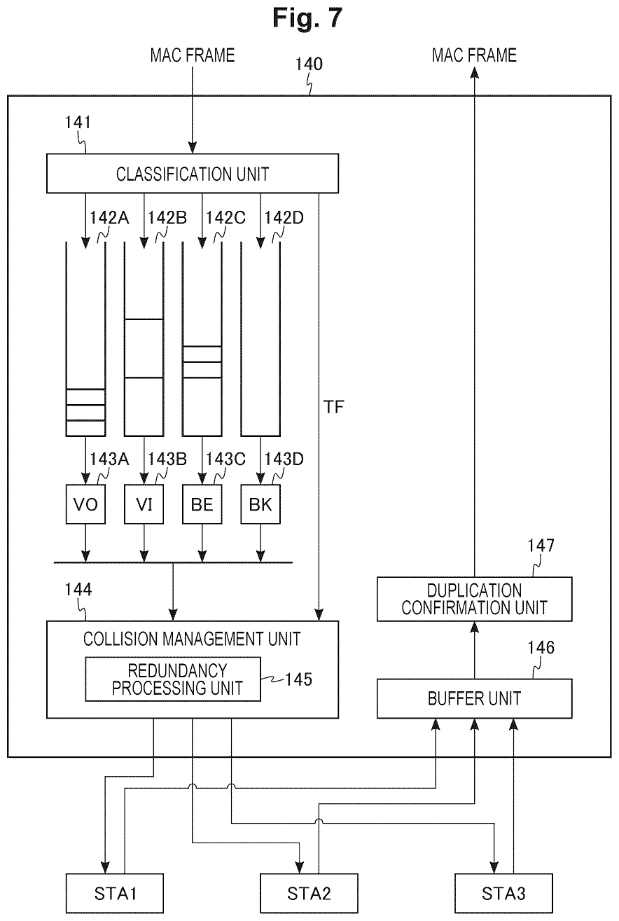

FIG. 7 is a block diagram illustrating one example of a functional configuration of the MAC frame processing unit 140 of the base station AP included in the information communication system 1 according to the embodiment. FIG. 7 illustrates details of a channel access function and an uplink data receiving function of the MAC frame processing unit 140.

First, the channel access function of the base station AP will be described. As illustrated in FIG. 7, in association with the channel access function, the MAC frame processing unit 140 includes, for example, a classification unit 141, transmission queues 142A, 142B, 142C, and 142D, carrier sensing execution units 143A, 143B, 143C, and 143D, and a collision management unit 144.

The classification unit 141 classifies the MAC frame received from the data processing unit 120 into a plurality of access categories on the basis of the TID included in the MAC header. Then, the classification unit 141 inputs the MAC frame to one of the corresponding transmission queues 142A, 142B, 142C, and 142D. In the present example, the classification unit 141 inputs VO data to the transmission queue 142A, inputs VI data to the transmission queue 142B, inputs BE data to the transmission queue 142C, and inputs BK data to the transmission queue 142D. Furthermore, the classification unit 141 inputs a trigger frame TF received from the trigger generation unit 137 or an instruction to generate the trigger frame TF to the collision management unit 144 without passing through the transmission queue 142, for example.

Each of the transmission queues 142A, 142B, 142C, and 142D buffers the input MAC frame. In the present example, the transmission queues 142A, 142B, 142C, and 142D buffer the data of VO, VI, BE, and BK, respectively.

Each of the carrier sensing execution units 143A, 143B, 143C, and 143D executes carrier sensing based on carrier sense multiple access with collision avoidance (CSMA/CA) according to an access parameter set in advance for each carrier sensing execution unit 143. The access parameter is set for each access category, and is set, for example, such that transmission of a wireless signal is prioritized in the order of “VO”, “VI”, “BE”, and “BK”. The carrier sensing execution units 143A, 143B, 143C, and 143D execute carrier sensing for the MAC frames buffered in the transmission queues 142A, 142B, 142C, and 142D, respectively. For example, in a case where the transmission right is acquired (that is, when the channel is idle), the carrier sensing execution unit 143A extracts the MAC frame from the transmission queue 142A. Then, the carrier sensing execution unit 143A outputs the extracted MAC frame to the wireless signal processing unit (for example, any one of STA1, STA2, and STA3) corresponding to the link associated with the access category “VO” via the collision management unit 144.

The collision management unit 144 prevents data transmission collision in a case where a plurality of carrier sensing execution units 143 acquires the transmission right for the same link. In other words, the collision management unit 144 adjusts the transmission timing of the data for which the transmission right is acquired by the same STA function, and outputs the data of the access category with high priority to the STA function. Note that the trigger frame TF can be processed with a lower latency than other traffic since carrier sensing is executed without passing through the transmission queue 142. Further, the collision management unit 144 includes a part that functions as a redundancy processing unit 145 in a case where a multilink is established and the TWT function is used.

When the traffic of which the transmission right is acquired by the collision management unit 144 is allocated to a plurality of links, the redundancy processing unit 145 outputs the MAC frame to be transmitted to each of at least two links among the plurality of links. In other words, the redundancy processing unit 145 duplicates (for example, duplexing) the MAC frame associated with a plurality of links and outputs the duplicated MAC frames to the two or more links among the plurality of links. Note that the redundancy processing unit 145 may customize the MAC frame input to each link so as to have unique information for each link. Furthermore, the redundancy processing unit 145 may duplicate only the common information and input the information to each link to cause each link to generate the MAC frame itself. When the trigger frame TF or an instruction to generate the trigger frame TF is input to the collision management unit 144, the redundancy processing unit 145 may output the trigger frame TF or the instruction to generate the trigger frame TF to the STA function in preference to other traffic. The redundancy processing unit 145 may include a beacon in the target of a frame to be made redundant.

Note that in the embodiment, the case where the MAC frame processing unit 140 implements the channel access function is exemplified, but the present invention is not limited thereto. For example, the wireless signal processing units 150, 160, and 170 may implement the channel access function. In this case, the redundancy processing unit 145 is configured as a part of link management. Specifically, the redundancy processing unit 145 duplicates a frame input from the MAC frame processing unit 140 and inputs the duplicated frame to each corresponding wireless signal processing unit. In addition, in a case where the trigger frame TF is transmitted, the redundancy processing unit 145 notifies each wireless signal processing unit of time information generated by the common time generation unit 136. As a result, each wireless signal processing unit can transmit the trigger frame TF at the same time on the basis of the time information.

As the access parameter, for example, CWmin, CWmax, AIFS, and TXOPLimit are used. CWmin and CWmax respectively indicate minimum and maximum values of a contention window which is a transmission waiting time for collision avoidance. An arbitration inter frame space (AIFS) indicates a fixed transmission waiting time set for each access category for collision avoidance control that has a priority control function. TXOPLimit indicates an upper limit value of a transmission opportunity (TXOP) corresponding to a channel occupancy time. The shorter the CWmin and CWmax are, the easier a transmission right of the transmission queue 142 is obtained. The smaller the AIFS is, the higher the priority of the transmission queue 142 is. The higher the value of TXOPLimit is, the larger an amount of data transmitted with one transmission right is.

Next, an uplink data receiving function of the base station AP will be described. As illustrated in FIG. 7, in association with the uplink data receiving function, the MAC frame processing unit 140 includes, for example, a buffer unit 146 and a duplication confirmation unit 147.

The buffer unit 146 temporarily stores a MAC frame received from each wireless signal processing unit (for example, STA1, STA2, and STA3). When a multilink is established, the buffer unit 146 may store MAC frames including the same information input from a plurality of links.

The duplication confirmation unit 147 confirms the MAC frames stored in the buffer unit 146, and discards frames including duplicate information while leaving one frame. Then, the duplication confirmation unit 147 outputs the MAC frame from which duplication has been eliminated to the data processing unit 120 or the management unit 130 according to the type of the MAC frame. For confirmation of duplication, the duplication confirmation unit 147 refers to, for example, the sequence number included in the MAC header. For confirmation of duplication, it is sufficient that at least common information included in the MAC frame is used.

### (Functional Configuration of Wireless Terminal Apparatus WTA)

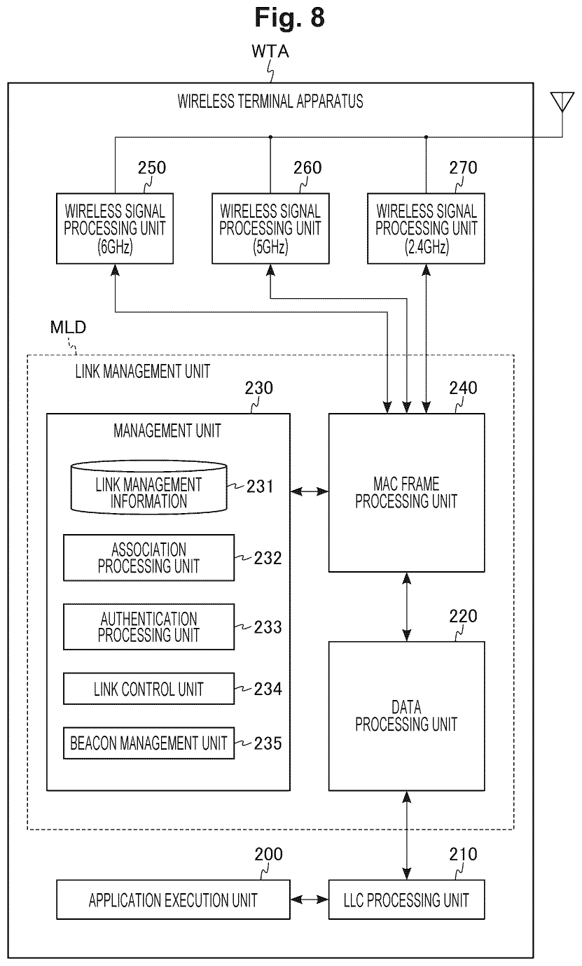

FIG. 8 is a block diagram illustrating one example of a functional configuration of the wireless terminal apparatus WTA included in the information communication system 1 according to the embodiment. As illustrated in FIG. 8, the wireless terminal apparatus WTA includes, for example, an application execution unit 200, an LLC processing unit 210, a data processing unit 220, a management unit 230, a MAC frame processing unit 240, and wireless signal processing units 250, 260, and 270. Processing of each of the application execution unit 200 and the LLC processing unit 210 can be implemented by, for example, the CPU 20 and the RAM 22. Processing of the data processing unit 220, the management unit 230, the MAC frame processing unit 240, and the wireless signal processing units 250, 260, and 270 can be implemented by, for example, a combination of the CPU 20, the RAM 22, and the wireless communication module 23.

The application execution unit 200 executes seventh-layer processing on the input data. The LLC processing unit 210 executes processing of the LLC sublayer of the second layer and processing of the third layer to the sixth layer on input data. The data processing unit 220, the management unit 230, and the MAC frame processing unit 240 execute second-layer MAC sublayer processing on the input data. The wireless signal processing units 250, 260, and 270 execute first-layer processing on the input data. Hereinafter, a set of the data processing unit 220, the management unit 230, and the MAC frame processing unit 240 included in the wireless terminal apparatus WTA is also referred to as “link management unit MLD of the wireless terminal apparatus WTA”.

Hereinafter, details of each functional configuration included in the wireless terminal apparatus WTA will be described.

The application execution unit 200 executes an application that can use data input from the LLC processing unit 210. Furthermore, the application execution unit 200 inputs data to the LLC processing unit 210 and acquires data from the LLC processing unit 210 in response to an operation of the application. The application execution unit 200 can display application information on the display 24. In addition, the application execution unit 200 can execute processing in response to an operation by the input interface.

The LLC processing unit 210 adds a DSAP header, an SSAP header, and the like to data received from the application execution unit 200 to generate an LLC packet. Then, the LLC processing unit 210 inputs the generated LLC packet to the data processing unit 220. In addition, the LLC processing unit 210 receives the LLC packet from the data processing unit 220 and extracts data from the received LLC packet. Then, the LLC processing unit 210 inputs the extracted data to the application execution unit 200.

The data processing unit 220 adds a MAC header to the LLC packet input from the LLC processing unit 210 to generate a MAC frame. Then, the data processing unit 220 inputs the generated MAC frame to the MAC frame processing unit 240. In addition, the data processing unit 220 receives the MAC frame from the MAC frame processing unit 240 and extracts the LLC packet from the received MAC frame. Then, the data processing unit 220 inputs the extracted LLC packet to the LLC processing unit 210.

The management unit 230 manages the state of the link between the base station AP and the wireless terminal apparatus WTA. Information related to control, management, and the like of a link can be exchanged between the management unit 230 and the MAC frame processing unit 240. Furthermore, the management unit 230 can instruct the MAC frame processing unit 240 to execute predetermined processing. The management unit 230 includes, for example, link management information 231, an association processing unit 232, an authentication processing unit 233, a link control unit 234, and a beacon management unit 235. The link management information 231 is a table including information related to a link with the wirelessly-connected base station AP, and includes, for example, the information illustrated in FIG. 3. The association processing unit 232 executes a protocol related to an association when transmitting a connection request to the base station AP. The authentication processing unit 233 executes a protocol related to authentication subsequent to the association. The link control unit 234 controls the state of a link with the wirelessly-connected base station AP. Furthermore, the link control unit 234 can determine association between a traffic type (TID) and an STA function when establishing multilink. The beacon management unit 235 manages information included in the beacon received from the base station AP. For example, the beacon management unit 235 receives management information included in the beacon, and instructs the link control unit 234 to control the link based on the management information. Note that the beacon management unit 235 may notify the data processing unit 220 of the content of the management information.

The MAC frame processing unit 240 receives the MAC frame from the data processing unit 220 or the management unit 230, and temporarily stores (buffers) the received MAC frame. The MAC frame processing unit 240 then refers to the link management information 231 to identify a link associated with a TID of data included in the MAC frame. Then, the MAC frame processing unit 240 executes carrier sensing. In a case where the channel is in a busy state, the MAC frame processing unit 240 continues the carrier sensing. In a case where the channel is in an idle state, the MAC frame processing unit 240 inputs the MAC frame to the wireless signal processing unit corresponding to the channel. Further, the MAC frame processing unit 240 receives the MAC frames from the wireless signal processing units 250, 260, and 270, and inputs the MAC frames to the data processing unit 220 or the management unit 230 according to the type of the MAC frames. For example, in a case where the MAC frame is a data frame, the MAC frame processing unit 240 inputs the MAC frame to the data processing unit 220, and in a case where the MAC frame is a management frame, the MAC frame processing unit 240 inputs the MAC frame to the management unit 230.

The wireless signal processing unit 250 adds a preamble, a physical layer (PHY) header, and the like to the data input from the MAC frame processing unit 240 to generate a wireless frame. Then, the wireless signal processing unit 250 performs a predetermined modulation operation on the wireless frame to convert the wireless frame into a wireless signal, and radiates (transmits) the wireless signal via the antenna. Further, the wireless signal processing unit 250 receives a wireless signal from the wireless terminal apparatus WTA via the antenna, and performs a predetermined demodulation operation on the received wireless signal to obtain a wireless frame. Then, the wireless signal processing unit 250 extracts the MAC frame from the wireless frame, and inputs the extracted MAC frame to the MAC frame processing unit 240. The functions of the wireless signal processing units 260 and 270 are similar to those of the wireless signal processing unit 250. In the present example, the wireless signal processing units 250, 260, and 270 handle wireless signals of the 6 GHz band, the 5 GHz band, and the 2.4 GHz band, respectively. That is, the wireless signal processing units 250, 260, and 270 correspond to STA1, STA2, and STA3 of the wireless terminal apparatus WTA, respectively. Note that the wireless signal processing units 250, 260, and 270 may share an antenna or may use individual antennas.

### (Functional Configuration of MAC Frame Processing Unit 240 of Wireless Terminal Apparatus WTA)

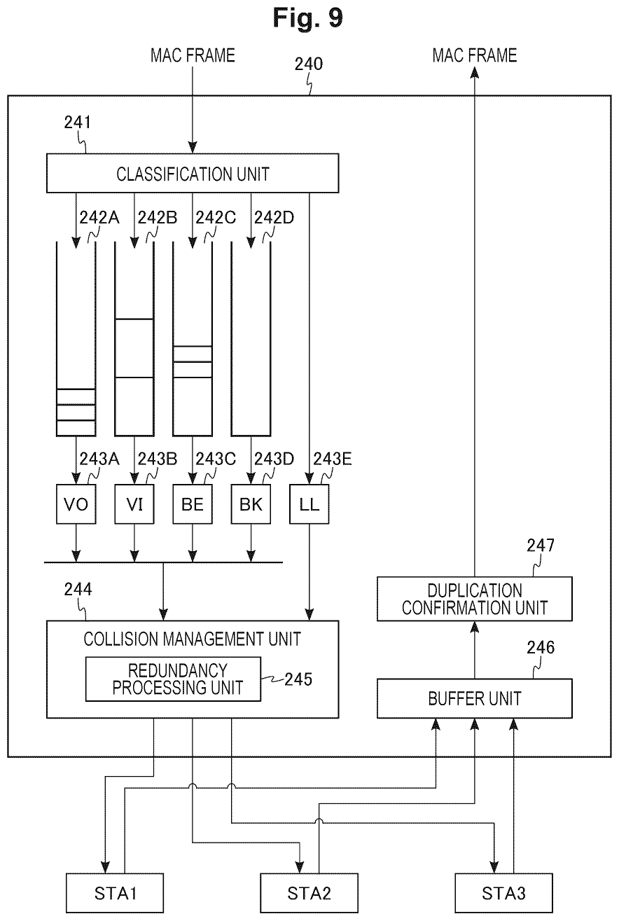

FIG. 9 is a block diagram illustrating one example of a functional configuration of the MAC frame processing unit 240 of the wireless terminal apparatus WTA included in the information communication system 1 according to the embodiment. FIG. 9 illustrates details of a channel access function and a downlink data receiving function of the MAC frame processing unit 240.

First, the channel access function of the wireless terminal apparatus WTA will be described. As illustrated in FIG. 9, in association with the channel access function, the MAC frame processing unit 240 includes, for example, a classification unit 241, transmission queues 242A, 242B, 242C, and 242D, carrier sensing execution units 243A, 243B, 243C, and 243D, and a collision management unit 244.

The classification unit 241 classifies the MAC frame received from the data processing unit 220 into a plurality of access categories on the basis of the TID included in the MAC header. Then, the classification unit 241 inputs the MAC frame to one of the corresponding transmission queues 242A, 242B, 242C, and 242D. In the present example, the classification unit 241 inputs VO data to the transmission queue 242A, inputs VI data to the transmission queue 242B, inputs BE data to the transmission queue 242C, and inputs BK data to the transmission queue 242D. In addition, the classification unit 241 inputs LL data (low latency data) for which low latency is required to a carrier sensing execution unit 243E without passing through the transmission queue 242, for example.

Each of the transmission queues 242A, 242B, 242C, and 242D buffers the input MAC frame. In the present example, the transmission queues 242A, 242B, 242C, and 242D buffer the data of VO, VI, BE, and BK, respectively.

Each of the carrier sensing execution units 243A, 243B, 243C, 243D, and 243E executes carrier sensing based on CSMA/CA according to an access parameter set in advance for each carrier sensing execution unit 243. Then, each of the carrier sensing execution units 243A, 243B, 243C, 243D, and 243E outputs the MAC frame for which the transmission right has been acquired to the associated link via the collision management unit 244. The access parameter is set such that, for example, transmission of a wireless signal is prioritized in the order of “LL”, “VO”, “VI”, “BE”, and “BK”. The carrier sensing execution units 243A, 243B, 243C, and 243D execute carrier sensing for the MAC frames buffered in the transmission queues 242A, 242B, 242C, and 242D, respectively. The carrier sensing execution unit 243E executes carrier sensing for the MAC frame of LL received from the classification unit 241. As described above, the MAC frame of LL can be processed with a lower latency than other traffic since carrier sensing is executed without passing through the transmission queue 242. Note that the carrier sensing execution unit 243E may skip carrier sensing in a case of data transmission in response to reception of the trigger frame TF.

The collision management unit 244 prevents data transmission collision in a case where a plurality of carrier sensing execution units 243 acquires the transmission right for the same link. Furthermore, the collision management unit 244 includes a part that functions as a redundancy processing unit 245 in a case where a multilink is established and the TWT function is used.

When the traffic of which the transmission right is acquired by the collision management unit 244 is allocated to a plurality of links, the redundancy processing unit 245 outputs the MAC frame to be transmitted to each of at least two links among the plurality of links. In other words, the redundancy processing unit 245 duplicates (for example, duplexing) the MAC frame associated with a plurality of links and outputs the duplicated MAC frames to the two or more links among the plurality of links. Note that the redundancy processing unit 245 may customize the MAC frame input to each link so as to have unique information for each link. Furthermore, the redundancy processing unit 245 may duplicate only the common information and input the information to each link to cause each link to generate the MAC frame itself. When the MAC frame of LL is input to the collision management unit 244, the redundancy processing unit 245 may output the MAC frame to the STA function in preference to other traffic.

Note that in the embodiment, the case where the MAC frame processing unit 240 implements the channel access function is exemplified, but the present invention is not limited thereto. For example, the wireless signal processing units 250, 260, and 270 may implement the channel access function.

Next, a downlink data receiving function of the wireless terminal apparatus WTA will be described. As illustrated in FIG. 9, in association with the downlink data receiving function, the MAC frame processing unit 240 includes, for example, a buffer unit 246 and a duplication confirmation unit 247.

The buffer unit 246 temporarily stores a MAC frame received from each wireless signal processing unit (for example, STA1, STA2, and STA3). When a multilink is established, the buffer unit 246 may store the MAC frames including the same information input from a plurality of links.

The duplication confirmation unit 247 confirms the MAC frames stored in the buffer unit 246, and discards frames including duplicate information while leaving one frame. Then, the duplication confirmation unit 247 outputs the MAC frame from which duplication has been eliminated to the data processing unit 220 or the management unit 230 according to the type of the MAC frame. For confirmation of duplication, the duplication confirmation unit 247 refers to, for example, the sequence number included in the MAC header. For confirmation of duplication, it is sufficient that at least common information included in the MAC frame is used. For example, when confirming that the buffer unit 246 has received and stored a beacon including the same information from a plurality of links, the duplication confirmation unit 247 eliminates duplication and outputs the information to the beacon management unit 235. When confirming that the buffer unit 246 has received and stored a trigger frame designating the same TWT service period from a plurality of links, the duplication confirmation unit 247 eliminates the duplication and outputs the trigger frame to the data processing unit 220 or the management unit 230.

### <2> Operation

### <2-1> Multilink Setup Method

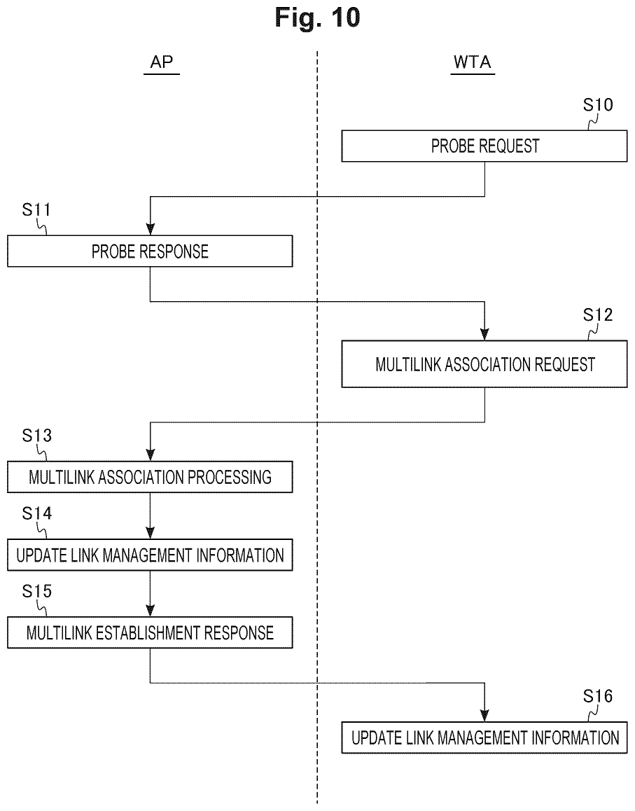

FIG. 10 is a flowchart illustrating one example of a multilink setup method in the information communication system 1 according to the embodiment. A multilink setup method will be described below with reference to FIG. 10. The multilink setup is executed between the link management unit MLD of the base station AP and the link management unit MLD of the wireless terminal apparatus WTA using, for example, a management frame.

In the processing of S10, the wireless terminal apparatus WTA transmits (broadcasts) a probe request to the base station AP. The probe request is a signal for confirming whether or not the base station AP exists around the wireless terminal apparatus WTA. When receiving the probe request, the base station AP executes processing of S11.

In the processing of S11, the base station AP transmits a probe response to the wireless terminal apparatus WTA. The probe response is a signal used for a response to a probe request from the wireless terminal apparatus WTA, and includes information necessary for establishing multilink. When receiving the probe response, the wireless terminal apparatus WTA executes processing of S12.

In the processing of S12, the wireless terminal apparatus WTA transmits a multilink association request to the base station AP via any STA function of the wireless terminal apparatus WTA. The multilink association request is a signal for requesting the base station AP to establish multilink, and includes information for multilink connection. When receiving the multilink association request, the link management unit MLD of the base station AP executes processing of S13.

In the processing of S13, the link management unit MLD of the base station AP executes multilink association processing. In the multilink association processing, the base station AP first executes association processing of the first STA function with the wireless terminal apparatus WTA. Then, when the wireless connection (link) is established in the first STA function, the link management unit MLD of the base station AP executes association processing of the second STA function using the first STA function for which the link has been established. When the association processing of at least two STA functions is completed, the base station AP recognizes that a multilink with the wireless terminal apparatus WTA has been established, and executes processing of S14.

In the processing of S14, the link management unit MLD of the base station AP updates the link management information 131. When the link management information 131 is updated, the base station AP executes processing of S15.

In the processing of S15, the base station AP transmits a multilink establishment response to the wireless terminal apparatus WTA. The multilink establishment response is a signal used for a response to the multilink request from the wireless terminal apparatus WTA. The link management unit MLD of the wireless terminal apparatus WTA recognizes that the multilink with the base station AP has been established on the basis of reception of the multilink establishment response, and executes processing of S16.

In the processing of S16, the link management unit MLD of the wireless terminal apparatus WTA updates the link management information 231. As a result, link management information is updated in both the base station AP and the wireless terminal apparatus WTA, and the multilink setup is completed. Thereafter, the base station AP and the wireless terminal apparatus WTA can execute data communication using the multilink.

Note that the multilink setup may be executed on the basis of a beacon periodically transmitted by the base station AP. In this case, the wireless terminal apparatus WTA executes the processing of S12 on the basis of reception of the beacon. That is, the processing of S10 and S11 can be omitted.

In addition, at the time of setting up the multilink, the link management unit MLD of each of the base station AP and the wireless terminal apparatus WTA executes mapping between each link included in the multilink and the traffic type (TID). Specifically, the link management unit MLD of the wireless terminal apparatus WTA determines association between traffic and a link, and requests the link management unit MLD of the base station AP to apply the association. Then, when the wireless terminal apparatus WTA receives a positive response to the request from the base station AP, the association between the traffic and the link is confirmed. For example, low latency data (traffic) is associated with at least two links among a plurality of links forming the multilink. The traffic associated with the plurality of links can be redundantly transmitted by the redundancy processing unit 145 or 245. Note that “the traffic is redundantly transmitted” corresponds to the same traffic being transmitted on a plurality of links forming the multilink.

### <2-2> TWT Function

Details of the TWT function in the embodiment will be described below.

The link management unit MLD of the base station AP or the wireless terminal apparatus WTA executes, for example, setup of the TWT function in order to exchange low latency data. The setup of the TWT function may be executed at the time of multilink setup, or may be executed on the basis of a transmission request of low latency data from the wireless terminal apparatus WTA after multilink is established. The parameter (hereinafter referred to as a TWT setting) used in the TWT function is set by the link management unit MLD of each of the base station AP and the wireless terminal apparatus WTA. The base station AP may manage the TWT setting for each wireless terminal apparatus WTA or for each group. In the embodiment, a case where the base station AP manages the TWT setting for each group will be described. Hereinafter, a group sharing a TWT setting is referred to as a “TWT group”. When using the TWT function, the base station AP assigns the wireless terminal apparatus WTA that has established a link to the TWT group.

The TWT setting is managed by the management unit 130 of the base station AP and the management unit 230 of the wireless terminal apparatus WTA. The TWT setting includes, for example, a TWT start time, a TWT cycle, and a TWT duration. The TWT start time corresponds to the start time of the TWT service period. The TWT cycle corresponds to the cycle of the TWT service period. The TWT cycle may be referred to as a TWT interval. The TWT duration corresponds to a period in which a transmission opportunity is given to the wireless terminal apparatus WTA. In the TWT duration, a plurality of links establishing a multilink with the base station AP is set in a state in which wireless signals can be received. When the TWT function is used, one cycle of the TWT service period can be identified by the TWT start time and the TWT duration.

The link management unit MLD of the wireless terminal apparatus WTA stands by for transmission of low latency data until the TWT service period, and causes each link to transmit the low latency data on the basis of reception of the trigger frame TF within the TWT service period. The cycle of the TWT service period is preferably set in accordance with the transmission cycle of low latency data of the wireless terminal apparatus WTA. Furthermore, the link management unit MLD of the base station AP may acquire the transmission cycle of low latency data to be reflected in the TWT setting by any method. For example, the link management unit MLD of the base station AP may acquire, from the wireless terminal apparatus WTA, a data generation cycle or the like set in an application that generates low latency data, and determine the TWT setting.

Note that the TWT start time may be expressed by the TWT cycle. The wireless terminal apparatus WTA can recognize, as the next TWT start time, a time obtained by adding the TWT cycle to the previous TWT start time as the start point. In other words, the wireless terminal apparatus WTA can recognize, as the start time of the next TWT duration, a time obtained by adding the TWT cycle to the previous TWT start time.

### (Outline of Uplink Data Transmission Method)

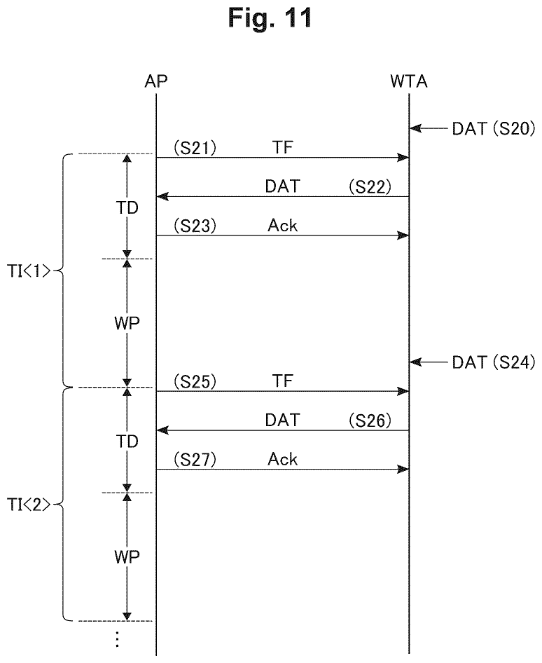

FIG. 11 is a sequence diagram illustrating one example of an uplink data transmission method when the TWT function is used in the information communication system 1 according to the embodiment. FIG. 11 illustrates a case where uplink data is transmitted in each of two consecutive TWT intervals TI <1> and TI <2>. Each of the TWT intervals TI <1> and TI <2> has a TWT duration TD and a standby period WP. The standby period WP corresponds to a period in which a transmission opportunity is not given while the TWT function is used. An outline of an uplink data transmission method will be described below with reference to FIG. 11.

The wireless terminal apparatus WTA buffers uplink data DAT1 before the TWT interval TI <1> (S20). When the start time of the TWT interval TI <1> comes, the base station AP transmits the trigger frame TF to the wireless terminal apparatus WTA within the TWT duration TD (S21). The timing at which the trigger frame TF is transmitted is preferably the TWT start time. In order to transmit the trigger frame TF at the TWT start time, each STA function may transmit the trigger frame TF by using a category of enhanced distributed channel access (EDCA) having the highest priority, or may transmit the trigger frame TF by a preferential transmission means different from EDCA. The wireless terminal apparatus WTA transmits the uplink data DAT1 to the base station AP on the basis of reception of the trigger frame TF (S22). When the base station AP successfully receives the uplink data DAT1, the base station AP transmits an Ack to the wireless terminal apparatus WTA (S23). By receiving the Ack after transmitting the uplink data DAT1, the wireless terminal apparatus WTA recognizes that the DAT1 is successfully transmitted, and discards the DAT1. The processing of S21 to S23 is executed within the TWT duration TD of the TWT interval TI <1>.

When the TWT duration TD ends within the TWT interval TI <1>, the processing proceeds to the standby period WP. In the present example, the wireless terminal apparatus WTA buffers uplink data DAT2 during the standby period WP of the TWT interval TI <1> (S24). When the start time of the TWT interval TI <2> comes, the base station AP transmits the trigger frame TF to the wireless terminal apparatus WTA within the TWT duration TD (S25). The wireless terminal apparatus WTA transmits the uplink data DAT2 to the base station AP on the basis of reception of the trigger frame TF (S26). When the base station AP successfully receives the uplink data DAT2, the base station AP transmits an Ack to the wireless terminal apparatus WTA (S27). By receiving the Ack after transmitting the uplink data DAT2, the wireless terminal apparatus WTA recognizes that the DAT2 is successfully transmitted, and discards the DAT2. The processing of S25 to S27 is executed within the TWT duration TD of the TWT interval TI <2>. Thereafter, the standby period WP of the TWT interval TI <2> is reached.

As described above, when the TWT function is used, the base station AP notifies the wireless terminal apparatus WTA of the data transmission opportunity using the trigger frame TF in the TWT duration TD of each TWT interval TI. Then, each time the wireless terminal apparatus WTA receives the trigger frame TF, the wireless terminal apparatus WTA attempts to transmit the buffered data to the base station AP.

### (Format of Trigger Frame TF)

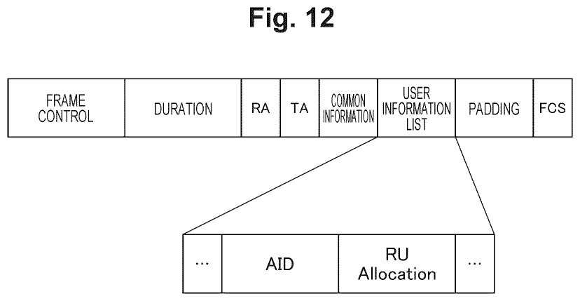

FIG. 12 is a conceptual diagram illustrating one example of a format of a trigger frame transmitted in the TWT period of the information communication system according to the embodiment. As illustrated in FIG. 12, a plurality of fields included in the trigger frame include, for example, a frame control field, a duration field, address fields (RA and TA), a common information field, a user information list field, a padding field, and a frame check sequence (FCS) field.

The frame control field stores various kinds of control information. For example, the frame control field includes information indicating a frame type of the wireless frame. The duration field indicates a scheduled period in which the wireless line is used. The address field indicates a BSSID, a transmission source address, a destination address, an address of a transmitter terminal, an address of a receiver terminal, and the like. The common information field includes information indicating a type of the trigger frame and the like. The user information list field includes, for example, “AID” and “resource unit (RU) allocation”. The wireless terminal apparatus WTA recognizes that the resource is allocated to its own station based on the AID. In addition, the wireless terminal apparatus WTA recognizes the allocated resource by RU allocation. The padding is a region for adjusting the data length of the wireless frame. The FCS field stores an error detection code of a set of a MAC header and a frame body field and is used to determine whether there is an error in the data frame.

### (Notification Method of TWT Setting)

The base station AP uses, for example, a beacon as a method of notifying the wireless terminal apparatus WTA of the TWT setting. The beacon including the TWT setting is generated and transmitted by, for example, the beacon management unit 135 of the base station AP. Furthermore, the TWT setting included in the beacon received by the wireless terminal apparatus WTA is acquired and managed by the beacon management unit 235. As a result, the beacon management unit 135 of the base station AP can notify the wireless terminal apparatus WTA of the TWT service period for transmitting low latency data. Then, the redundancy processing unit 145 of the base station AP may include a beacon as the target of a frame to be made redundant. That is, the beacon management unit 135 can cause each link to transmit a beacon that announces a TWT setting such as the TWT start time and the TWT duration in order to transmit low latency data.

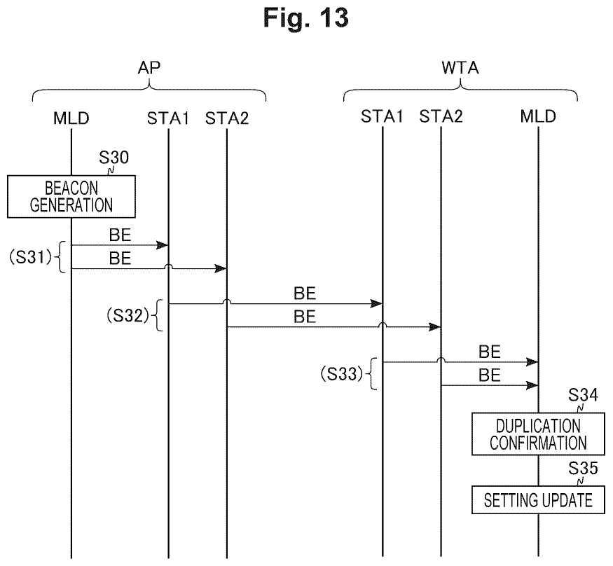

FIG. 13 is a sequence diagram illustrating one example of a beacon transmission and reception method in the information communication system 1 according to the embodiment. Hereinafter, one example of a notification method of TWT setting in a case where multilink is established when the TWT function is used will be described with reference to FIG. 13.

First, the link management unit MLD of the base station AP generates a beacon BE including the TWT setting (S30; beacon generation). Then, the link management unit MLD of the base station AP makes the beacon BE redundant, and inputs the beacon BE to each of STA1 and STA2 of the base station AP (S31). Then, each of STA1 and STA2 of the base station AP radiates (transmits) a wireless signal including the beacon BE via the antenna (S32). The wireless signals radiated (transmitted) by STA1 and STA2 of the base station AP are received in parallel by STA1 and STA2 of the wireless terminal apparatus WTA, respectively.

Next, each of STA1 and STA2 of the wireless terminal apparatus WTA inputs the beacon BE acquired from the received wireless signal to the link management unit MLD of the wireless terminal apparatus WTA (S33). The link management unit MLD of the wireless terminal apparatus WTA confirms whether there is duplication in the beacons input from STA1 and STA2 (S34; duplication confirmation). Duplication is eliminated from the beacon whose duplication has been confirmed, and the beacon is input to the beacon management unit 235 of the management unit 230. Then, the beacon management unit 235 updates the TWT setting on the basis of the TWT setting included in the received beacon (S35; setting update).

### (Beacon Format)

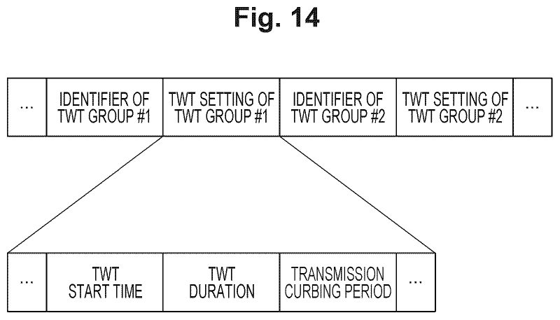

FIG. 14 is a conceptual diagram illustrating one example of a format of a beacon including a TWT setting used in the information communication system 1 according to the embodiment. As illustrated in FIG. 14, a beacon may include an identifier of a TWT group and a TWT setting for each identifier. Specifically, a beacon sequentially stores sets of a TWT group and a TWT setting, such as “identifier of TWT group #1”, “TWT setting of TWT group #1”, “identifier of TWT group #2”, and “TWT setting of TWT group #2”. The wireless terminal apparatus WTA can determine whether or not the TWT setting is for its own station on the basis of the set of the identifier of the TWT group and the TWT setting. Note that a beacon may be in another format as long as the wireless terminal apparatus WTA can determine the set of the TWT group and the TWT setting.

The TWT setting for each AID included in the beacon includes, for example, a TWT start time, a TWT duration, and a transmission curbing period. The transmission curbing period indicates a period in which transmission of uplink data to the wireless terminal apparatus WTA is curbed or prohibited. The wireless terminal apparatus WTA curbs or prohibits transmission of uplink data in a designated transmission curbing period. When receiving a beacon, the beacon management unit 235 of each wireless terminal apparatus WTA acquires the TWT start time, the TWT duration, and the transmission curbing period, and notifies each link (STA function) of the information. As a result, the base station AP can autonomously curb transmission of uplink data within the TWT service period in which low latency data is transmitted to the wireless terminal apparatuses WTA other than the wireless terminal apparatus WTA to which transmission of low latency data is assigned among the plurality of wireless terminal apparatuses WTA connected wirelessly.

### (Uplink Data Transmission Method)

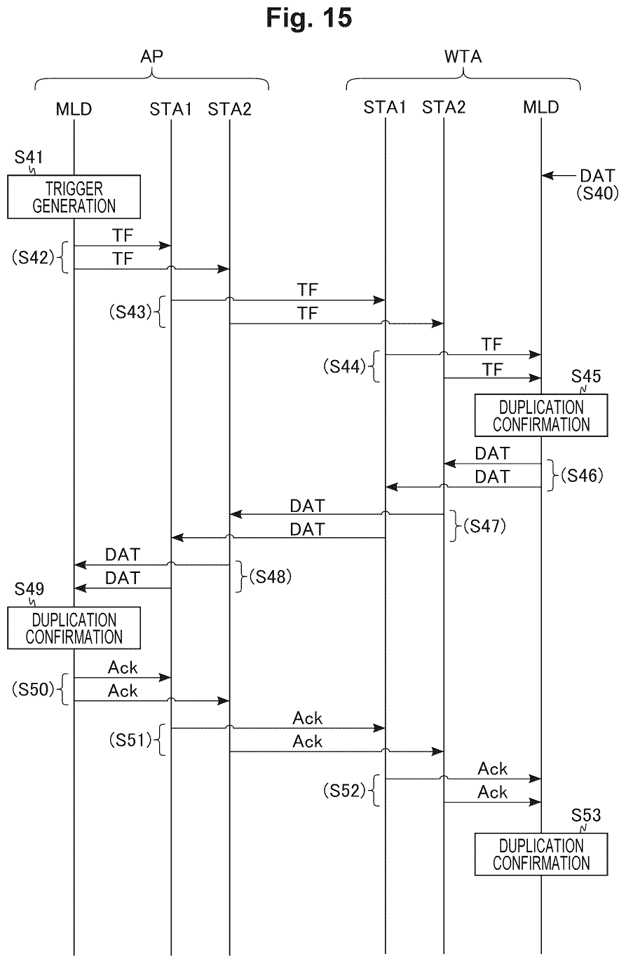

FIG. 15 is a sequence diagram illustrating one example of the uplink data transmission method when the TWT function of the information communication system 1 according to the embodiment is used. FIG. 15 illustrates a case where low latency uplink data is transmitted in a redundant manner in a certain TWT service period. An uplink data transmission method will be described below with reference to FIG. 15.

The link management unit MLD of the wireless terminal apparatus WTA buffers uplink data DAT in the MAC frame processing unit 240, for example, before the TWT service period (S40). When the TWT service period starts, the link management unit MLD of the base station AP generates the trigger frame TF (S41; trigger generation). Then, the link management unit MLD of the base station AP makes the trigger frame TF redundant by the redundancy processing unit 145, and inputs the trigger frame TF to each of STA1 and STA2 of the base station AP (S42). Then, each of STA1 and STA2 of the base station AP radiates (transmits) a wireless signal including the trigger frame TF via the antenna (S43). In other words, in the processing of S41 to S43, the trigger generation unit 137 generates the trigger frame TF for causing the wireless terminal apparatus WTA to transmit the uplink data DAT, inputs the trigger frame TF to each of the plurality of links forming the multilink via the redundancy processing unit 145, and causes the plurality of links to transmit the uplink data DAT. The wireless signals radiated (transmitted) by STA1 and STA2 of the base station AP are received in parallel by STA1 and STA2 of the wireless terminal apparatus WTA, respectively.

Next, each of STA1 and STA2 of the wireless terminal apparatus WTA inputs the trigger frame TF acquired from the received wireless signal to the link management unit MLD of the wireless terminal apparatus WTA (S44). The link management unit MLD of the wireless terminal apparatus WTA confirms whether there is duplication in the trigger frames TF input from STA1 and STA2 (S45; duplication confirmation). Duplication is eliminated from the trigger frame TF whose duplication has been confirmed, and the trigger frame TF is input to the link control unit 234 of the management unit 230. Then, the link control unit 234 causes the MAC frame processing unit 240 to redundantly input the uplink data DAT to each of STA1 and STA2 of the wireless terminal apparatus WTA on the basis of the received trigger frame TF (S46). Then, each of STA1 and STA2 of the wireless terminal apparatus WTA radiates (transmits) a wireless signal including the uplink data DAT via the antenna (S47). The wireless signals radiated (transmitted) by STA1 and STA2 of the wireless terminal apparatus WTA and including the uplink data DAT are received in parallel by STA1 and STA2 of the base station AP, respectively.

Next, each of STA1 and STA2 of the wireless terminal apparatus WTA inputs the uplink data DAT acquired from the received wireless signal to the link management unit MLD of the wireless terminal apparatus WTA (S48). The link management unit MLD of the wireless terminal apparatus WTA confirms whether there is duplication in the uplink data DAT input from STA1 and STA2 (S49; duplication confirmation). Duplication is eliminated from the uplink data DAT whose duplication has been confirmed, and the uplink data DAT is input to the data processing unit 120. As a result, the link management unit MLD of the base station AP recognizes that the uplink data DAT has been successfully received.

Next, the link management unit MLD of the base station AP makes the Ack redundant and inputs the Ack to each of STA1 and STA2 of the base station AP on the basis of the successful reception of the uplink data DAT (S50). Then, each of STA1 and STA2 of the base station AP radiates (transmits) a wireless signal including Ack via the antenna (S51). The wireless signals radiated (transmitted) by STA1 and STA2 of the base station AP and including the Ack are received in parallel by STA1 and STA2 of the wireless terminal apparatus WTA, respectively.

Next, each of STA1 and STA2 of the wireless terminal apparatus WTA inputs the Ack acquired from the received wireless signal to the link management unit MLD of the wireless terminal apparatus WTA (S52). The link management unit MLD of the wireless terminal apparatus WTA confirms whether there is duplication in the Acks input from STA1 and STA2 (553; duplication confirmation). Duplication is eliminated from the Ack whose duplication has been confirmed, and the Ack is input to the management unit 230. As a result, the link management unit MLD of the base station AP recognizes that the uplink data DAT has been successfully transmitted. Then, the link management unit MLD of the wireless terminal apparatus WTA discards the buffered uplink data DAT and completes the transmission of the uplink data DAT.

Note that, in each link, the base station AP may transmit the information of the transmission curbing period in a certain period starting from the TWT cycle and the information of all links to be subjected to transmission curbing by a beacon. On the basis of this information, the link management unit MLD of the wireless terminal apparatus WTA other than that of the wireless terminal apparatus WTA that transmits the low latency data notifies each STA function not to perform channel access on any link. In addition, the link management unit MLD of the base station AP curbs channel access in a link with the wireless terminal apparatus WTA other than the wireless terminal apparatus WTA that transmits the low latency data in the transmission curbing period. As a result, while a certain wireless terminal apparatus WTA is transmitting low latency data, data transmission in other wireless terminal apparatuses WTA is prohibited, and interference with a wireless signal transmitting the low latency data can be curbed.

### <3> Advantageous Effects of Embodiment

Multilink data communication can achieve efficient communication and improve communication speed by using a plurality of bands in combination. On the other hand, the power consumption of a multilink is higher than that of a single link because a plurality of STA functions are used in each of the base station AP and the wireless terminal apparatus WTA. Therefore, when traffic is not stagnated, it is preferable to perform a power save operation on each link forming the multilink. However, when the period of the power save operation becomes long, there is a possibility that a delay in transmission of uplink data becomes large.

As a method of curbing delay of low latency data in the uplink, it is conceivable to allocate periodic uplink data transmission using the TWT function. Specifically, when uplink data is periodically input, it is preferable to match the cycle in which the uplink data is input with the cycle of the TWT service period. As a result, the delay time of the queue of the low latency data can be reduced, and the power consumption of the multilink can be curbed. However, in a case where there is interference on the channel at the assumed transmission timing, there is a possibility that the transmission of the low latency data fails. If the transmission fails, there is a possibility that the low latency data cannot be transmitted within a desired delay time.

Therefore, the base station AP and the wireless terminal apparatus WTA according to the embodiment copy the low latency data to a plurality of links and transmit the data in a redundant manner, thereby increasing the possibility that the data or the like is transmitted at an assumed timing. Specifically, in the base station AP, the link management unit MLD that controls each wireless signal processing unit (STA function) generates information (a beacon, a trigger frame, or the like) to be transmitted in synchronization (commonization) with a plurality of links forming the multilink, and controls transmission. Furthermore, the link management unit MLD of the wireless terminal apparatus WTA duplicates data at a transmission timing shared among the plurality of links, outputs the data to each STA function, and controls transmission.

As a result, in the base station AP and the wireless terminal apparatus WTA according to the embodiment, when the TWT function is used, data and the like exchanged between the base station AP and the wireless terminal apparatus WTA are redundantly transmitted and received in parallel using multilink. Therefore, data and the like transmitted in parallel between the base station AP and the wireless terminal apparatus WTA only need to be successfully transmitted in one transmission even when the other transmission fails due to the influence of interference or the like. Accordingly, the base station AP and the wireless terminal apparatus WTA according to the embodiment can increase the probability that low latency data is transmitted when the TWT function is used, and can curb delay of data transmitted in the uplink.

### <4> Others

The configuration and functional configuration of the information communication system 1 according to the embodiment may be other configurations. For example, a case where each of the base station AP and the wireless terminal apparatus WTA has three STA functions (wireless signal processing units) has been exemplified, but the present invention is not limited thereto. The base station AP only needs to include at least two wireless signal processing units. Similarly, the wireless terminal apparatus WTA only needs to include at least two wireless signal processing units. The number of channels that can be processed by each STA function can be appropriately set according to the frequency band to be used. Each of the wireless communication modules 13 and 23 may correspond to wireless communication of a plurality of frequency bands by a plurality of communication modules, or may correspond to wireless communication of a plurality of frequency bands by one communication module. The functional configurations of the base station AP and the wireless terminal apparatus WTA may have other names and be grouped in other ways as long as the operations described in the embodiment can be executed.

In the information communication system 1 according to the embodiment, each of the CPU 10 included in the base station AP and the CPU 20 included in the wireless terminal apparatus WTA may be another circuit. For example, each of the base station AP and the wireless terminal apparatus WTA may include a micro processing unit (MPU) or the like instead of the CPU. Each of the processing described in the embodiment may be implemented by dedicated hardware. The processing of each of the base station AP and the wireless terminal apparatus WTA may include processing executed by software and processing executed by hardware in combination or may include only one of the processing.

In the embodiment, the flowchart used to describe the operation is merely one example. Each operation described in the embodiment may be interchanged within a possible processing order, or other processing may be added. For example, the multilink setup method described in the embodiment is merely one example. Furthermore, the format of a wireless frame described in the embodiment is merely one example. In the information communication system 1, other formats may be used as long as the operations described in the embodiment can be executed. A wireless communication standard different from the IEEE 802.11 standard may be used as the wireless communication between the base station AP and the wireless terminal apparatus WTA.

Note that the present invention is not limited to the above embodiment and various modifications may be made in the implementation stage without departing from the gist of the invention. In addition, the embodiments may be appropriately combined and implemented, and in this case, combined effects can be obtained. Furthermore, the above embodiments include various inventions, and various inventions can be extracted by combinations selected from a plurality of disclosed components. For example, in a case where the problems can be solved and the advantageous effects can be obtained even if some components are deleted from all the components described in the embodiments, a configuration from which the components are deleted can be extracted as an invention.

### REFERENCE SIGNS LIST

AP Base station
WTA Wireless terminal apparatus
1 Information communication system
10 CPU
11 ROM
12 RAM
13 Wireless communication module
14 Wired communication module
110 LLC processing unit
120 Data processing unit
130 Management unit
131 Link management information
132 Association processing unit
133 Authentication processing unit
134 Link control unit
135 Beacon management unit
136 Common time generation unit
137 Trigger generation unit
140 MAC frame processing unit
141 Classification unit
142 Transmission queue
143 Carrier sensing execution unit
144 Collision management unit
145 Redundancy processing unit
146 Buffer unit
147 Duplication confirmation unit
150, 160, 170 Wireless signal processing unit
20 CPU
21 ROM
22 RAM
23 Wireless communication module
24 Display
25 Storage
200 Application execution unit
210 LLC processing unit
220 Data processing unit
230 Management unit
231 Link management information
232 Association processing unit
233 Authentication processing unit
234 Link control unit
235 Beacon management unit
240 MAC frame processing unit
241 Classification unit
242 Transmission queue
243 Carrier sensing execution unit
244 Collision management unit
245 Redundancy processing unit
246 Buffer unit
247 Duplication confirmation unit
250, 260, 270 Wireless signal processing unit

1. A base station comprising:
a first wireless signal processing circuit;
a second wireless signal processing circuit; and
a processor configured to establish a multilink with a wireless terminal apparatus using the first wireless signal processing circuit and the second wireless signal processing circuit, wherein
the processor is configured to generate a trigger frame for causing the wireless terminal apparatus to transmit uplink data, and cause each of the first wireless signal processing circuit and the second wireless signal processing circuit to transmit the trigger frame.

2. The base station according to claim 1, wherein
in a case where the first wireless signal processing circuit and the second wireless signal processing circuit receive first uplink data and second uplink data in parallel, the processor is configured to confirm whether there is duplication between the first uplink data and the second uplink data, and when there is duplication, the processor is configured to output one of the first uplink data and the second uplink data to an upper layer.

3. The base station according to claim 1, wherein
the processor is configured to set a cycle of transmitting the trigger frame to the wireless terminal apparatus in accordance with a transmission cycle of low latency data of the wireless terminal apparatus.

4. The base station according to claim 3, wherein
the processor is configured to cause each of the first wireless signal processing circuit and the second wireless signal processing circuit to transmit a beacon including information related to the transmission cycle of the trigger frame.

5. A wireless terminal apparatus comprising:
a first wireless signal processing circuit;
a second wireless signal processing circuit; and
a processor configured to establish a multilink with a base station using the first wireless signal processing circuit and the second wireless signal processing circuit, wherein
when receiving a trigger frame instructing transmission of uplink data from the base station, the processor is configured to cause each of the first wireless signal processing circuit and the second wireless signal processing circuit to transmit the uplink data.

6. The wireless terminal apparatus according to claim 5, wherein
in a case where the first wireless signal processing circuit and the second wireless signal processing circuit receive a first trigger frame and a second trigger frame in parallel, the processor is configured to confirm whether there is duplication between the first trigger frame and the second trigger frame, and when there is duplication, the processor is configured to output the uplink data to each of the first wireless signal processing circuit and the second wireless signal processing circuit using one of the first trigger frame and the second trigger frame as the trigger frame.

7. The wireless terminal apparatus according to claim 5, wherein
the processor is configured to bring each of the first wireless signal processing circuit and the second wireless signal processing circuit into a state capable of receiving a wireless signal on the basis of information related to a transmission cycle of the trigger frame received from the base station.

8. The wireless terminal apparatus according to claim 7, wherein
the uplink data is low latency data, and
the processor is configured to wait for transmission of the uplink data until the trigger frame is received.
